(19) United States
(12) Patent Application Publication
(10) Pub. No.: US 2016/0144920 A1
(43) Pub. Date: May 26, 2016

(54) SUPPORTING BRACKET AND BICYCLE HAVING THE SAME

(71) Applicants: Fu Tai Hua Industry (Shenzhen) Co., Ltd., Shenzhen (CN); HON HAI PRECISION INDUSTRY CO., LTD., New Taipei (TW)

(72) Inventors: GANG-HUA LIU, Shenzhen (CN); CHIEH-YU LEE, New Taipei (TW)

(21) Appl. No.: 14/587,311

(22) Filed: Dec. 31, 2014

(30) Foreign Application Priority Data
Nov. 26, 2014 (CN) 201410703416.X

(51) Int. Cl. B62J 11/00

(52) U.S. Cl. CPC B62J 11/00

(57) ABSTRACT

A bicycle includes a stem and a supporting bracket for supporting an electronic product. The supporting bracket includes a mounting apparatus mounted on the stem, a tray for receiving the electronic product, and an adjusting apparatus connected between the mounting apparatus and the tray. The adjusting apparatus includes a positioning pipe mounted to the mounting apparatus and a sliding pole slidably connected to the positioning pipe. The tray is rotatably connected to a top end of the sliding pole.

### FIELD

The subject matter herein generally relates to a bicycle with a supporting bracket.

### BACKGROUND

An electronic device, such as a mobile telephone or an avigraph, may be mounted to a stem of a bicycle through a mounting apparatus.

### BRIEF DESCRIPTION OF THE DRAWINGS

Implementations of the present technology will now be described, by way of example only, with reference to the attached figures.

FIG. 1 is an exploded, partial isometric view of an embodiment of a bicycle, wherein the bicycle includes a supporting bracket.

FIG. 2 is similar to FIG. 1, but viewed from another angle.

FIG. 3 is an enlarged view of a circled portion III of FIG. 1.

FIG. 4 is an assembled, isometric view of the bicycle of FIG. 1.

FIG. 5 is a cross sectional view of FIG. 4, taken along line V-V.

FIG. 6 is similar to FIG. 4, but showing the supporting bracket in a state of use.

FIG. 7 is similar to FIG. 6, but showing the supporting bracket in another state of use.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder.

The term “comprising” means “including, but not necessarily limited to”; it specifically indicates open-ended inclusion or membership in a so-described combination, group, series and the like.

The present disclosure is described in relation to a bicycle.

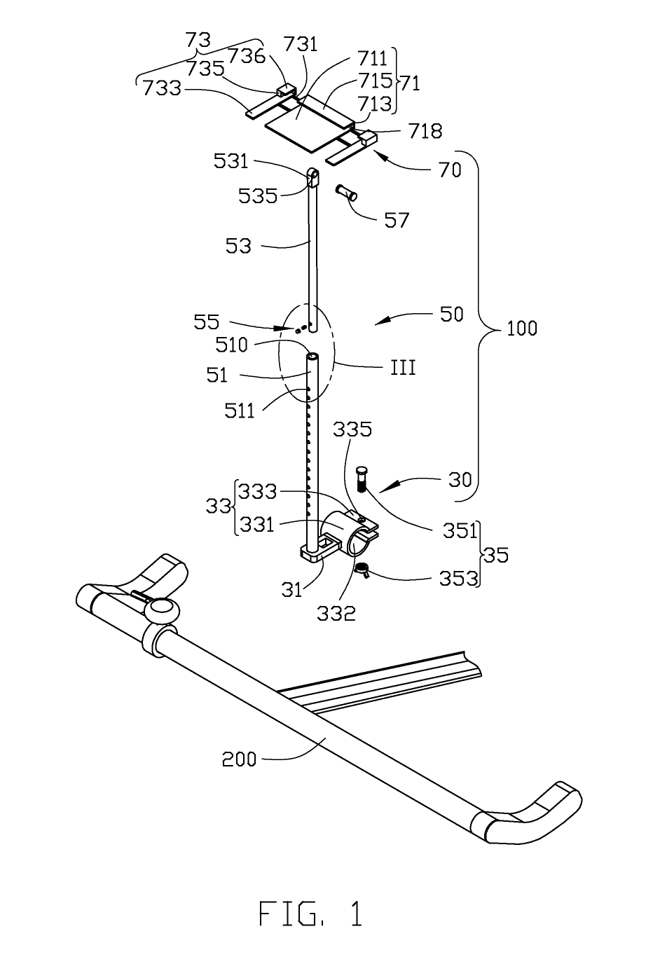

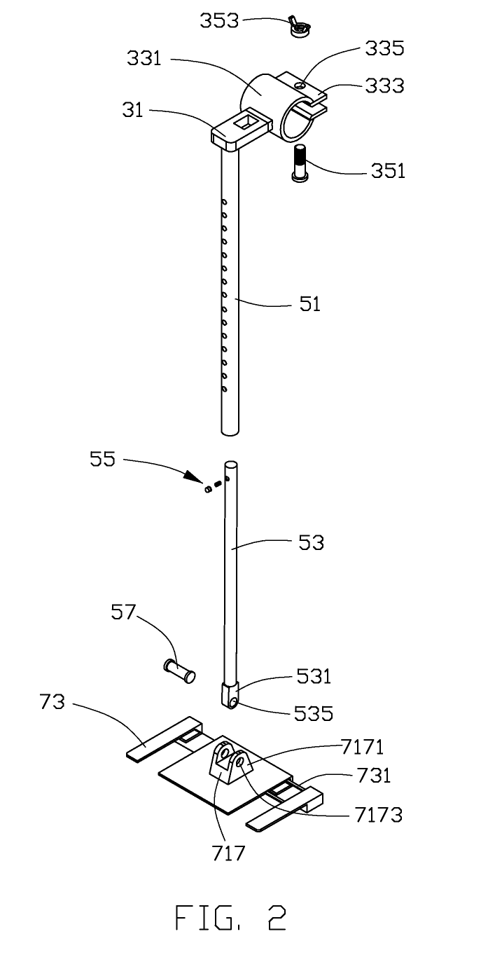

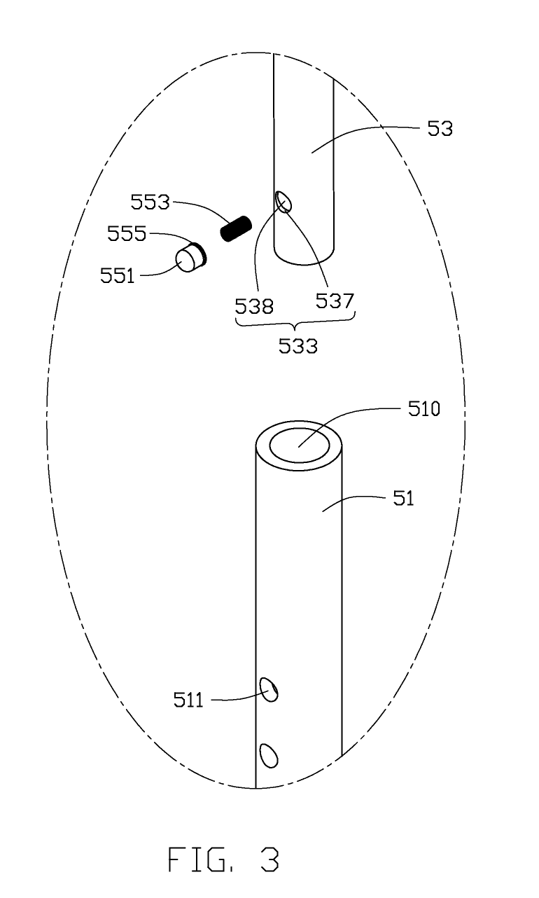

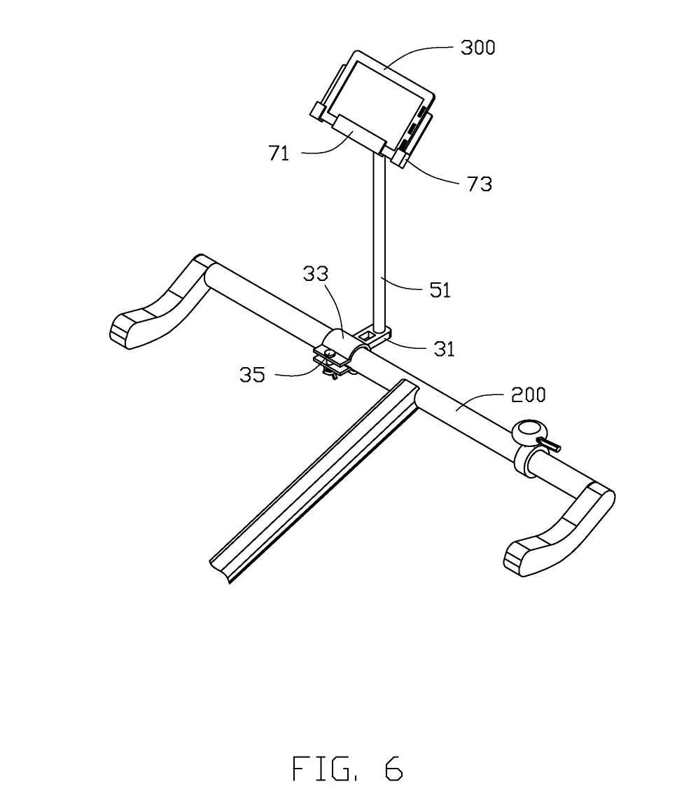

FIGS. 1-3 illustrate an embodiment of a bicycle comprising a supporting bracket 100 and a stem 200. The supporting bracket 100 is configured to install an electronic product 300 (shown as FIG. 6) to the stem 200. The supporting bracket 100 comprises a mounting apparatus 30, an adjusting apparatus 50, and a tray 70. In at least one embodiment, the electronic product 300 is an avigraph.

The mounting apparatus 30 comprises a supporting block 31, a sleeve 33, and a locking member 35. The sleeve 33 comprises a substantially C-shaped resilient sleeve body 331 and two spaced tabs 333 respectively extending out from two distal ends of the sleeve body 331. A middle of each tab 333 defines a through hole 335. An end of the supporting block 31 is mounted substantially perpendicular to a middle portion of an outer surface of the sleeve body 331 away from the tabs 333. The sleeve body 331 axially defines a space 332. In at least one embodiment, the locking member 35 comprises a screw 351 and a nut 353 fitting about the screw 351.

The adjusting apparatus 50 comprises a hollow positioning pipe 51, a sliding pole 53 slidably inserted in the positioning pipe 51, a latching assembly 55, and a shaft 57. The positioning pipe 51 axially defines a guiding slot 510 extending through a top end surface of the positioning pipe 51. A bottom end of the positioning pipe 51 is mounted substantially perpendicular to the supporting block 31 away from the sleeve 33.

The positioning pipe 51 defines a plurality of positioning holes 511 communicating with the guiding slot 510. The positioning holes 511 are arrayed in a line along a lengthwise direction of the positioning pipe 51. A connecting bar 531 protrudes up from a top end of the sliding pole 53. A step hole 533 is defined in the sliding pole 53 adjacent to a bottom end of the sliding pole 53. A diameter of an opening 537 of the step hole 533 is less than a diameter of an inner part 538 of the step hole 533 away from the opening 537. An upper end of the connecting bar 531 defines a rotating hole 535 perpendicular to a lengthwise direction of the sliding pole 53.

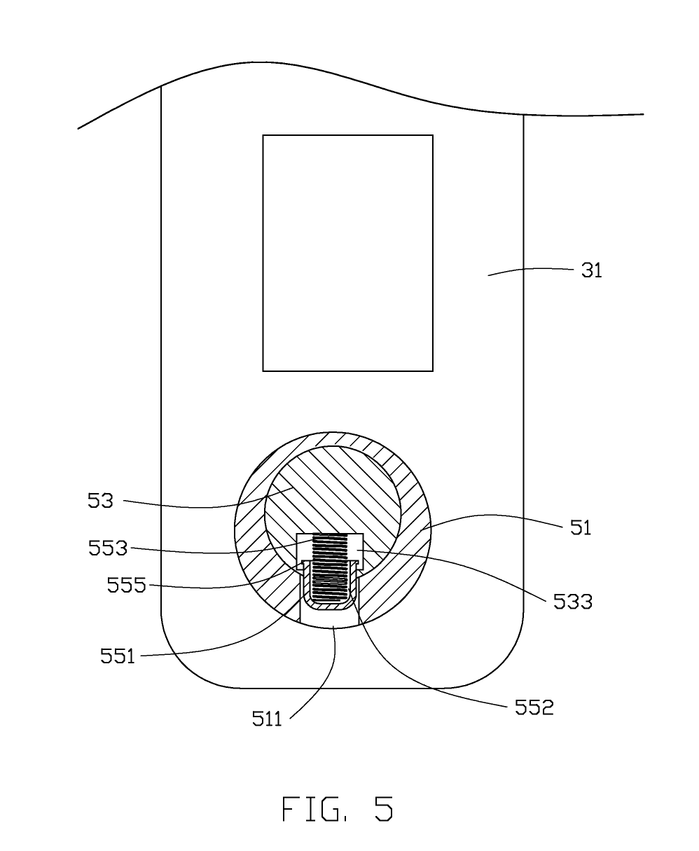

The latching assembly 55 comprises a locking pin 551 and a resilient member 553. A first end of the locking pin 551 axially defines a latching hole 552 (shown as FIG. 5). An annular resilient latching piece 555 protrudes outward from the circumference of the first end of the locking pin 551. A second end of the locking pin 551 away from the latching piece 555 is substantially hemispherical. In at least one embodiment, the resilient member 553 is a spring.

The tray 70 comprises a receiving bracket 71 and two clamping members 73. The receiving bracket 71 comprises a supporting plate 711, a rear plate 713 extending substantially perpendicular up from a rear side of the supporting plate 711, a stop plate 715 extending substantially perpendicular forward from a top side of the rear plate 713, and a connecting block 717 protruding down from a middle portion of a bottom surface of the supporting plate 711. The supporting plate 711, the rear plate 713, and the stop plate 715 cooperatively bind a receiving slot 718. The connecting block 717 comprises two spaced and opposite connecting pieces 7171 perpendicular to the supporting plate 711. Each connecting piece 7171 is resilient, and defines a rotating hole 7173 extending along a direction parallel to the supporting plate 711 and the rear plate 713. A distance between the connecting pieces 7171 is less than a width of the connecting bar 531 along the axial direction of the rotating hole 535. The clamping members 73 are connected to two opposite sides of the supporting plate 711 through a plurality of sliding bars 731. Each clamping member 73 can move toward and away from the receiving bracket 71 through the corresponding sliding bars 731. Each clamping member 73 comprises a supporting bar 733 connected to first ends of the corresponding sliding bars 731, a substantially L-shaped stopping piece 735 perpendicularly extending up from a rear edge and an outer edge adjacent to the rear edge of the supporting bar 733, and a latching piece 736 extending substantially perpendicular forward from a top of the stopping piece 735.

In the embodiment, the first end of each sliding bar 731 is mounted to the corresponding clamping member 73, and a second end of each sliding bar 731 is slidably connected to the supporting plate 711.

In another embodiment, the first end of each sliding bar 731 is slidably connected to the corresponding clamping member 73, and the second end of each sliding bar 731 is mounted to the supporting plate 711.

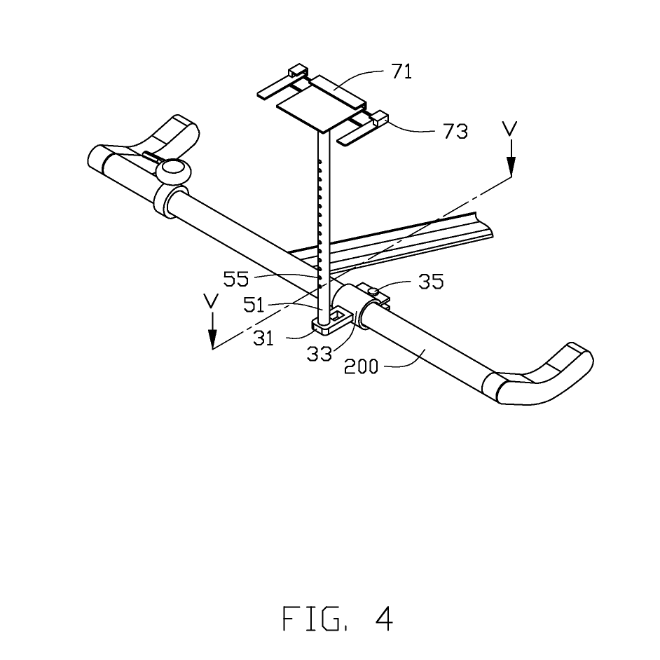

FIGS. 4-5 illustrate that, to assemble the supporting bracket 100, the connecting pieces 7171 of the connecting block 717 are deformed away from each other. The connecting bar 531 of the sliding pole 53 is inserted between the connecting pieces 7171, to allow the rotating hole 535 of the connecting bar 531 to align with the rotating holes 7173 of the connecting block 717. Releasing the connecting pieces 7171, the connecting pieces 7171 are restored to clamp the connecting bar 531 of the sliding pole 53. An end of the shaft 57 passes through the rotating hole 7173 of one of the connecting pieces 7171, the rotating hole 535 of the connecting bar 531, and is mounted in the rotating hole 7173 of the other connecting piece 7171. The tray 70 is rotatably connected to the sliding pole 53 about the shaft 57, and can be positioned through a friction force between the connecting bar 531 and the connecting pieces 7171.

A first end of the resilient member 553 is mounted in the latching hole 552 of the locking pin 551, and a second end of the resilient member 553 is exposed out of the locking pin 551. The second end of the resilient member 553 is inserted into the step hole 533 through the opening 537, and the locking pin 551 aligns with the step hole 533. The locking pin 551 is pressed toward the step hole 533, a circumference wall bounding the opening 537 deforms the latching piece 555, until the latching piece 555 passes through the opening 537. The latching piece 555 is restored to resist against an inner step wall of the step hole 533 around the opening 537, and the resilient member 553 is resiliently sandwiched between the locking pin 551 and the sliding pole 53. The second end of the locking pin 551 is exposed out of an outer surface of the sliding pole 53.

The locking pin 551 is pressed toward the step hole 533 and deforms the resilient member 553, until the second end of the locking pin 551 is received in the opening 537. The bottom end of the sliding pole 53 is inserted into the guiding slot 510 of the positioning pipe 51. The second end of the locking pin 551 slidably abuts against an inner surface of the positioning pipe 51 bounding the guiding slot 510, until the second end of the locking pin 551 aligns with one of the positioning hole 511. The resilient member 553 is restored to bias the locking pin 551 to latch in the corresponding positioning hole 511. The sliding pole 53 is mounted to the positioning pipe 51.

The tabs 333 of the sleeve 33 are pulled away from each other, deforming the sleeve body 331. The stem 200 is installed in the space 332 of the sleeve body 331 from a slot between the tabs 333. Releasing the tabs 333, the sleeve body 331 is restored to clamp the stem 200. The screw 351 passes through the through holes 335 and is fastened to the nut 353. The mounting apparatus 30 is mounted on the stem 200.

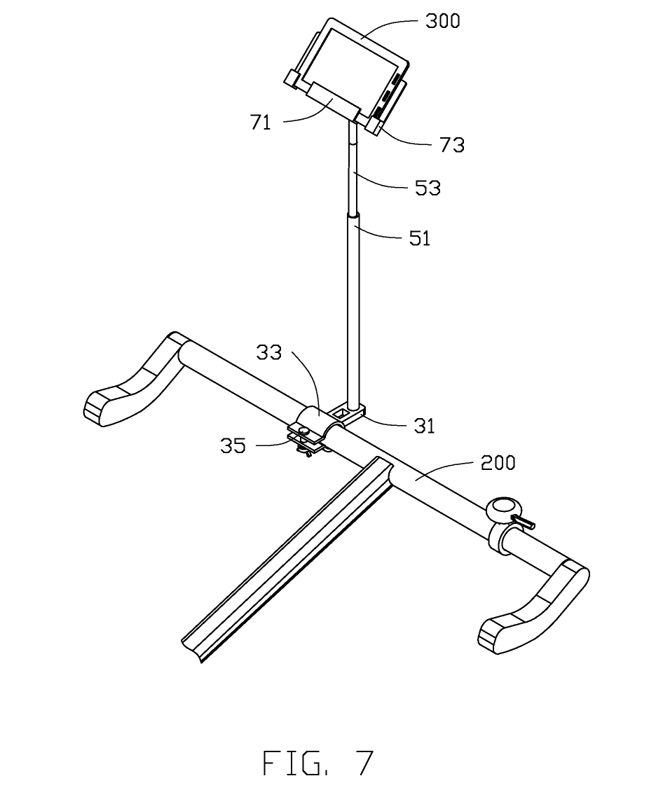

FIGS. 6-7 illustrate that in use, the tray 70 is rotated about the shaft 57, until the receiving slot 718 is located below the tray 70. Each clamping member 73 is slid away from the receiving bracket 71, until a distance between the clamping members 73 is greater than a length of the electronic product 300. A rear side of the electronic product 300 is received in the receiving slot 718. Each clamping member 73 is slid toward the receiving bracket 71, until the stopping piece 735 of the clamping member 73 abuts against the electronic product 300. The tray 70 can be rotated about the shaft 57 between 0 degree and 90 degree, so it is convenient to adjust an angle of the electronic device 300. The locking pin 551 is pressed toward the step hole 533 and deforms the resilient member 553, until the second end of the locking pin 551 is disengaged from the corresponding positioning hole 511. The sliding pole 53 is rotated relative to the positioning pipe 51, to allow the locking pin 551 away from the line of positioning holes 511, and the second end of locking pin 551 slidably abuts against the inner surface of the positioning pipe 51 bounding the guiding slot 510. The sliding pole 53 is slid along the lengthwise direction of the guiding slot 510, until the electronic device 300 arrives at a desired height. The sliding pole 53 is rotated relative to the positioning pipe 51, until the second end of the locking pin 551 aligns with the corresponding positioning hole 511. The resilient member 553 is restored to bias the locking pin 551 to latch in the corresponding positioning hole 511.

Even though numerous characteristics and advantages of the embodiments have been set forth in the foregoing description, together with details of the structure and function of the embodiments, the present disclosure is illustrative only, and changes may be made in details, including in the matters of shape, size, and arrangement of parts within the principles of the embodiments to the full extent indicated by the broad general meaning of the terms in which the appended claims are expressed.

What is claimed is:

1. A supporting bracket configured to be mounted to a bicycle for supporting an electronic product, the supporting bracket comprising:
a mounting apparatus configured to be mounted on the bicycle;
a tray configured to receive the electronic product; and
an adjusting apparatus connected between the mounting apparatus and the tray, wherein the adjusting apparatus comprises a positioning pipe mounted to the mounting apparatus and a sliding pole slidably connected to the positioning pipe, the tray is rotatably connected to a top end of the sliding pole.

2. The supporting bracket of claim 1, wherein the mounting apparatus comprises a supporting block, a resilient sleeve, and a locking member, a bottom end of the positioning pipe is mounted to a first end of the supporting block, the sleeve comprises a substantially C-shaped sleeve body and two tabs extending out from two distal ends of the sleeve body, a second end of the supporting block opposite to the positioning pipe is mounted to an outer surface of the sleeve body, the locking member fastens the tabs.

3. The supporting bracket of claim 1, wherein the positioning pipe axially defines a guiding slot extending through a top end surface of the positioning pipe, a bottom end of the sliding pole is slidably inserted in the guiding slot of the positioning pipe.

4. The supporting bracket of claim 3, wherein the positioning pipe defines a plurality of positioning holes communicating with the guiding slot, the positioning holes are arrayed in a line along a lengthwise direction of the positioning pipe, the sliding pole comprises a resilient latching assembly installed to a lower portion of the sliding pole, the latching assembly is configured to latch in a corresponding one of the positioning holes to lock the sliding pole to the positioning pipe.

5. The supporting bracket of claim 4, wherein the latching assembly comprises a locking pin radially and slidably connected to the sliding pole and a resilient member resiliently sandwiched between the locking pin and the sliding pole.

6. The supporting bracket of claim 5, wherein the lower portion of the sliding pole defines a step hole, a diameter of an opening of the step hole is less than a diameter of an inner part of the step hole away from the opening, the resilient member is installed in the step hole of the sliding pole, a first end of the locking pin is slidably received in the step hole, a latching piece protrudes outward from a circumference of the first end of the locking pin, to be blocked by an inner step wall of the step hole around the opening, the resilient member is sandwiched between the locking pin and the sliding pole to bias the locking pin to slide outward, to allow a second end of the locking pin away from the resilient member to latch in the corresponding positioning hole.

7. The supporting bracket of claim 6, wherein the second end of the locking pin is hemispherical.

8. The supporting bracket of claim 1, wherein the tray comprises a receiving bracket, a connecting block protruding down from a bottom of the receiving bracket, and two clamping members slidably connected to two opposite sides of the receiving bracket to clamp the electronic product, each clamping member is capable of sliding toward and away from the receiving bracket, the sliding pole is rotatably connected to the connecting block.

9. The supporting bracket of claim 8, wherein the receiving bracket comprises a supporting plate, a rear plate substantially perpendicularly extending up from a rear side of the supporting plate, a stop plate substantially perpendicularly extending forward from a top side of the rear plate, the supporting plate, the rear plate, and the stop plate cooperatively bind a receiving slot for receiving at least a rear portion of the electronic product.

10. The supporting bracket of claim 8, wherein the connecting block comprises two spaced and opposite connecting pieces extending downward, each connecting piece is resilient, a distance between the connecting pieces is less than a width of the top end of the sliding pole, the top end of the sliding pole is rotatably connected between the connecting pieces and is capable of being positioned to a plurality of angles through a friction force between the sliding pole and the connecting pieces.

11. The supporting bracket of claim 9, wherein each clamping member comprises a supporting bar slidably connected to the supporting plate through at least one sliding bar and a stopping piece extending up from a rear edge and an outer edge adjacent to the rear edge of the supporting bar.

12. A bicycle comprising:
a stem; and
a supporting bracket configured to be mounted to the stem for supporting an electronic product, the supporting bracket comprising:
a mounting apparatus configured to be mounted on the stem;
a tray configured to receive the electronic product; and
an adjusting apparatus connected between the mounting apparatus and the tray, wherein the adjusting apparatus comprises a positioning pipe mounted to the mounting apparatus and a sliding pole slidably connected to the positioning pipe, the tray is rotatably connected to a top end of the sliding pole.

13. The bicycle of claim 12, wherein the mounting apparatus comprises a supporting block, a resilient sleeve fitted about the stem, and a locking member, a bottom end of the positioning pipe is mounted to the supporting block, the sleeve comprise an arc-shaped sleeve body and two tabs extending out from two distal ends of the sleeve body, the supporting block is mounted to the sleeve body, the locking member fastens the tabs.

14. The bicycle of claim 12, wherein the positioning pipe axially defines a guiding slot extending through an top end surface of the positioning pipe, the positioning pipe further defines a plurality of positioning holes communicating with the guiding slot, the positioning holes are arrayed in a line along a lengthwise direction of the positioning pipe, the sliding pole comprises a resilient latching assembly installed to a lower portion of the sliding pole, the lower portion of the sliding pole is slidably received in the guiding slot, and the latching assembly is configured to latch in a corresponding one of the positioning holes to lock the sliding pole to the positioning pipe.

15. The bicycle of claim 14, wherein the latching assembly comprises a locking pin radially and slidably connected to the sliding pole and a resilient member resiliently sandwiched between the locking pin and the sliding pole.

16. The bicycle of claim 15, wherein the lower portion of the sliding pole defines a step hole, a diameter of an opening of the step hole is less than a diameter of an inner part of the step hole away from the opening, the resilient member is installed in the step hole of the sliding pole, a first end of the locking pin is slidably received in the step hole, a latching piece protrudes out from the first end of the locking pin stopping to an inner step wall of the step hole around the opening, the resilient member is sandwiched between the locking pin and the sliding pole to bias the locking pin to slide outward to latch in the corresponding positioning hole.

17. The bicycle of claim 12, wherein the tray comprises a receiving bracket, a connecting block protruding down from a bottom of the receiving bracket, and two clamping members slidably connected to two opposite sides of the receiving bracket to clamp the electronic product, each clamping member is configured to slide adjacent to or away from the receiving bracket, the sliding pole is rotatably connected to the connecting block.

18. The bicycle of claim 17, wherein the receiving bracket comprises a supporting plate, a rear plate substantially perpendicularly extending up from a rear side of the supporting plate, a stop plate substantially perpendicularly extending forward from a top side of the rear plate, the supporting plate, the rear plate, and the stop plate cooperatively bind a receiving slot for receiving at least a rear portion of the electronic product.
